(19) United States
(12) Patent Application Publication
(10) Pub. No.: US 2017/0108874 A1
(43) Pub. Date: Apr. 20, 2017

(54) VISION-BASED SYSTEM FOR NAVIGATING A ROBOT THROUGH AN INDOOR SPACE

(71) Applicant: ASECO INVESTMENT CORP., Oakville (CA)

(72) Inventors: Robert PETERS, St. Catharines (CA); Chanh Vy Tran, Mississauga (CA); Trevor Louis Ablett, Whitby (CA); Lucas James Lepore, Hamilton (CA); Matthew James Sergenese, Thorold (CA)

(21) Appl. No.: 14/886,698

(22) Filed: Oct. 19, 2015

(51) Int. Cl. G05D 1/02; G06T 7/60; G06T 7/40; G06K 9/46; G06T 7/00; H04N 7/18; G06K 9/52

(52) U.S. Cl. CPC G05D 1/0246; H04N 7/18; G06T 7/60; G06K 9/52; G06K 9/4604; G06T 7/0085; G06K 9/4652; G06T 7/408; G05D 1/0212; G05D 1/0234; Y10S 901/01

(57) ABSTRACT

Methods, systems, and devices are provided for navigating a robot along a route. Navigation is accomplished using an image sensor mounted on the robot, which captures an image of a target. The target comprises a plurality of data zones and a plurality of data indicators organized with no more than one data indicator located within one data zone. The target has a target code based on which of the data zones contains the plurality of data indicators. A target distance between the robot and the target is determined, and, if the target distance is below a distance threshold, then an instruction, based on the target code is used to command the robot.

### TECHNICAL FIELD

The disclosure herein relates to robot navigation, and in particular, to systems and methods for autonomous robot navigation.

The application of autonomous robot technology towards industrial and commercial warehouses and fulfillment centers has been found to improve the productivity of storing, retrieving, and shipping inventory.

Autonomous robots are able to perform various tasks, such as picking up, relocating, and delivering an inventory payload within a warehouse. The performance of these tasks by robots rather than humans allows for real time computer-optimized routing and efficient aggregation of multiple payload pick-up and delivery trips.

Currently, there are autonomous robots used in commercial ware-houses and fulfillment centers that rely on wire guidance, or the use of electric and/or magnetic tracks embedded within a building, such as in the floor. When a track is embedded in the floor of a building, a robot sensing the track is able to navigate the building through constant reference to the track.

Systems that use wire guidance or a navigation track that can be sensed by the robot require extensive infrastructure that is not only costly to install, but is also static and difficult to alter or adapt when different robot routing is desired

While there are attempts to find alternatives to wire-guidance and navigation-track systems using optical means, the current solutions rely on laser-guided autonomous robots that use complex mapping and image analysis systems. These systems require complex and costly equipment in order to implement the laser-guidance, mapping, and image analysis.

There currently exists a need for the ability to navigate an autonomous robot in a large indoor space, without the use of any specific track infrastructure or complex laser-guidance systems.

### SUMMARY

According to one aspect, there is provided a method for navigating a robot along a route. The method comprises the steps of: using an image sensor that is mounted on the robot to capture an image of a target having a target code; determining a target distance between the robot and the target; and, if the target distance is below a distance threshold, then determining an instruction based on the target code and commanding the robot based on the instruction. The target comprises a plurality of data zones and a plurality of data indicators organized with no more than one data indicator located within one data zone. The target has a target code based on which of the data zones contains the plurality of data indicators.

According to another aspect, there is provided a robot navigation system The system comprises a target having a plurality of data zones and a plurality of data indicators organized with no more than one data indicator located within one data zone. The target has a target code based on which of the data zones contains the plurality of data indicators. The system further comprises a robot having an image sensor for capturing an image of the target, a drive system for driving and steering the robot, and a processing unit. The processing unit is configured to determine a target distance between the robot and the target, and, if the target distance is below a distance threshold, then determine an instruction from the encoded information and instructing the drive system to steer the robot based on the instruction.

The target distance may be determined based on a resolution of the image, a dimension of the target, and a field-of-view angle of the image sensor. The resolution of the image may include a height of the image, and the dimension of the target may be a height of the target.

The target distance may be determined based on the formula:

$${T}_{D} = \frac{{T}_{H} * {l}_{Wpix}}{2 * {T}_{Hpix} * Tan ( \frac{{θ}_{FOV}}{2} )}$$

where T_{D} is the target distance, T_{H} is the actual height of the target 512 (e.g. as measured in feet), I_{Wpix} the width of the image (e.g., as measured in pixels), T_{Hpix} is the height of the target 512 in the image 514 (e.g. as measured in pixels), and θ_{FOV} is the field-of-view angle.

The method may further comprise the steps of: determining a skew angle between the robot and the target; and, if the skew angle is above a angle tolerance threshold, then steering the robot towards a center of the target.

The skew angle may be determined based on the height of a first side of the target, the height of a second side of the target, and the width of the target.

The skew angle may be determined based on the formula

$${θ}_{skew} = {tan}^{- 1} \frac{( {h}_{2} - {h}_{1} )}{2 w}$$

where θ_{skew} is the skew angle, h₁ and h₂ are the heights of the side edges of the sign, and w is the width of the sign.

The skew angle may be determined based on the formula

$${θ}_{skew} = {tan}^{- 1} \frac{( {Y}_{1} - {Y}_{2} )}{( {X}_{1} - {X}_{2} )}$$

where is the skew angle, Y₂ and Y₁ are, respectively, the y-coordinates of a top-left corner and a top-right corner of the target in the image, and X₂ and X₁ are, respectively the x-coordinates of a top-left corner and a top-right corner of the target in the image

The method may further comprise the steps of: determining a route distance offset between the robot and a centerline extending from the target; and, if the route distance offset is above a distance tolerance threshold, then steering the robot towards the centerline.

The instruction used to command the robot may be one of changing direction, picking up a payload, and delivering the payload.

According to another aspect, there is provided a robot-navigation target device comprising a base defining a base surface, a border attached to the base surface, which encloses an inferior area with a matrix representing a plurality of data zones, and a plurality of data indicators, organized with each data indicator being located within one data zone. The plurality of data indicators are organized to represent encoded information based on the data zones that contain a data indicator.

The interior area may have a contrasting color relative to the color of the border and the color of the plurality of data indicators.

The plurality of data indicators may be organized in order to represent a binary number.

The base surface may be a retro-reflective surface, and the interior area may be defined by a non-reflective overlay on the retro-reflective surface. The plurality of data indicators may be defined by cut-outs on the non-reflective overlay.

### BRIEF DESCRIPTION OF THE DRAWINGS

Some embodiments of the present disclosure will now be described, by way of example only, with reference to the following drawings, in which:

FIG. 1 is a schematic top view of a robot navigation system, according to one embodiment;

FIG. 2 is a front view of a target device used in a robot navigation system, according to one embodiment;

FIG. 3 is a front view of a target device used in a robot navigation system, according to one embodiment;

FIG. 4 is a front view of four target devices displaying encoded information according to one embodiment;

FIG. 5 is a schematic top view and vertical plane projection of a robot navigation system, according to one embodiment;

FIG. 6 is a front view of an image including a target device, according to one embodiment;

FIG. 7 is a front view of an image including a target device, according to one embodiment;

FIG. 8 is a schematic top view of a robot navigation system in a first navigation scenario, according to one embodiment;

FIG. 9 is a schematic top view of the robot navigation system of FIG. 8 in a second navigation scenario;

FIG. 10 is a schematic top view of the robot navigation system of FIG. 8 in a third navigation scenario, according to one embodiment; and

FIG. 11 is a flow diagram of a method for navigating a robot along a route, according to one embodiment.

### DETAILED DESCRIPTION

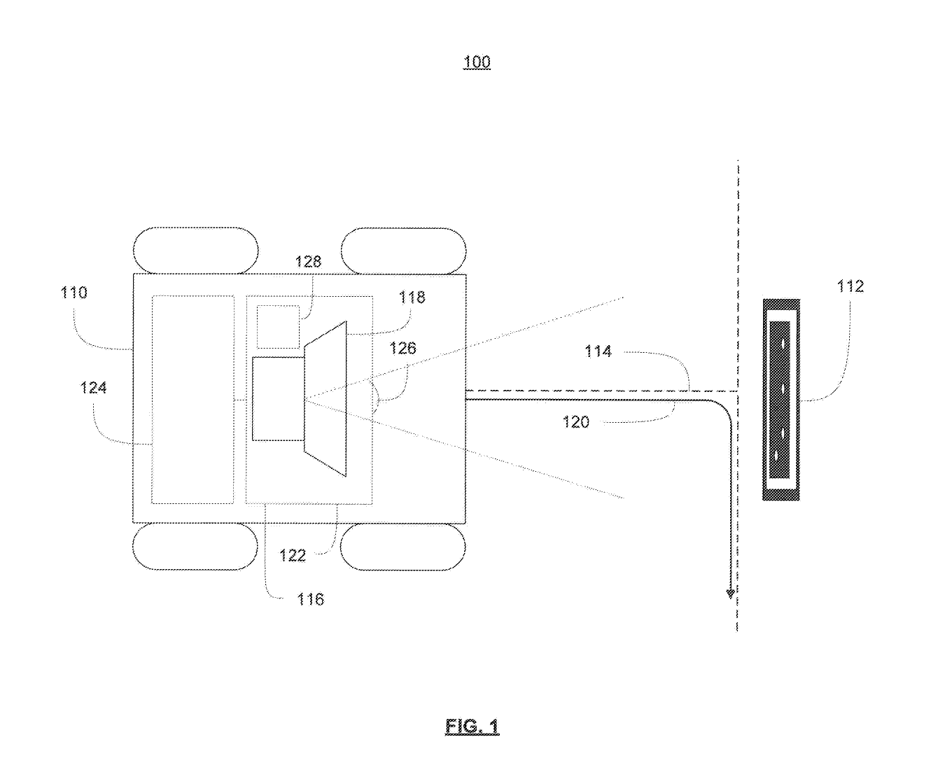

Referring to FIG. 1, there is shown a robot navigation system 100. The robot navigation system 100 comprises a robot 110 and a target 112.

The robot 110 is an autonomously-controlled robot that has the ability to navigate pre-defined indoor paths through the use of the structured targets (e.g. target 112) and a vision system 118 that includes a camera 118 mounted on the robot 110.

The path 114 (or “roadway”) is defined by a series of structured targets (e.g. target 112) that are mounted above the floor of an indoor space, such as a warehouse or fulfillment center. As will be further described below, each target has a series of symbols that are used to uniquely identify the target.

An electronic map is created that includes all the target identifiers embedded in the map. Each target has associated properties, such as indicating whether the target is at a junction where the robot 110 can turn, or at a station where the robot 110 can pick up or deliver a payload (such as packages).

When the robot 110 picks up a payload, it receives information providing a destination for the payload. The robot 110 uses the electronic map to determine a path 120 (the “robot route”) that will take the robot 110 from its current location to the destination for the pay load.

According to some embodiments, the robot route 120 may comprise a list of targets and actions, (e.g. turn left or right, go straight, deliver the payload, etc.).

The robot vision system 118 is used to identity the next target, which may include using the physical characteristics of the target and the captured image of the target to guide the robot from one target to the next target along the robot route 120.

The robot 110 uses a navigation system that includes the vision system 116, as well as a navigation control system 122, and a drive system 124 for moving and steering the robot 110.

The vision system 118 comprises an image sensor or camera 118, which has a field-of-view angle 126.

The navigation control system 122 comprises a processing unit 128, which, according to some embodiments, may be a .microprocessor, a microcontroller, or other processing unit.

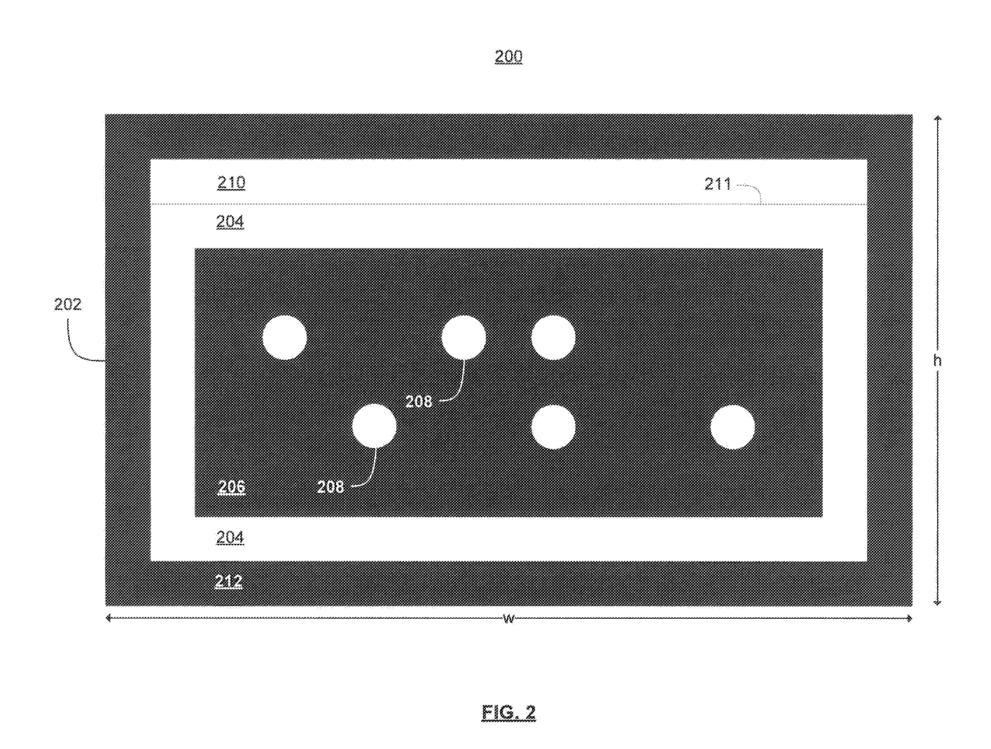

Referring to FIG. 2, there is shown a target 200, according to some embodiments. The target 200 comprises a base 202, which may be a sheet of plastic, wood, metal, cardboard, paper, etc. The targets are mounted above the roadway or robot route such that the robot's camera can pass beneath the centerline of the target. The targets are also mounted such that they are perpendicular to both the floor and the roadway or robot route,

The physical dimensions of the target 200 include a height h and a width w, which are known and can be recorded for future reference as the target height and the target width. According to some embodiments, the targets have a rectangular shape, while in other embodiments, other shapes may be used, such as square, discoid, etc. According to some embodiments, the dimensions (and shape) of each target is essentially the same for a particular installation or system.

As shown in FIG. 2, the target 200 comprises a border region 204. The border region 204 is used by the navigation system to determine whether the robot is traveling along the center of the robot route.

The target 200 also comprises an interior area 206 that is enclosed by the border 204, and which includes a pattern of data indicators 208.

According to some embodiments, the border region 204 may be a retro-reflective surface, or, alternatively, colored with a contrasting color to the interior area 206.

According to some embodiments, the target 200 may comprise a header region 210. The header region 210 may be used to display information that is in a human-readable formal, such as a company name and/or logo, a title or name of the target, a title or name of the system or Installation, a target name or human-readable identification number, etc. As shown in FIG. 2, there is a line 211 separating the header 210 from the upper section of the border 204. This line 211 is shown for explanatory purposes, and an actual target may or may not include this line 211 to distinguish the border 204 from the header 210.

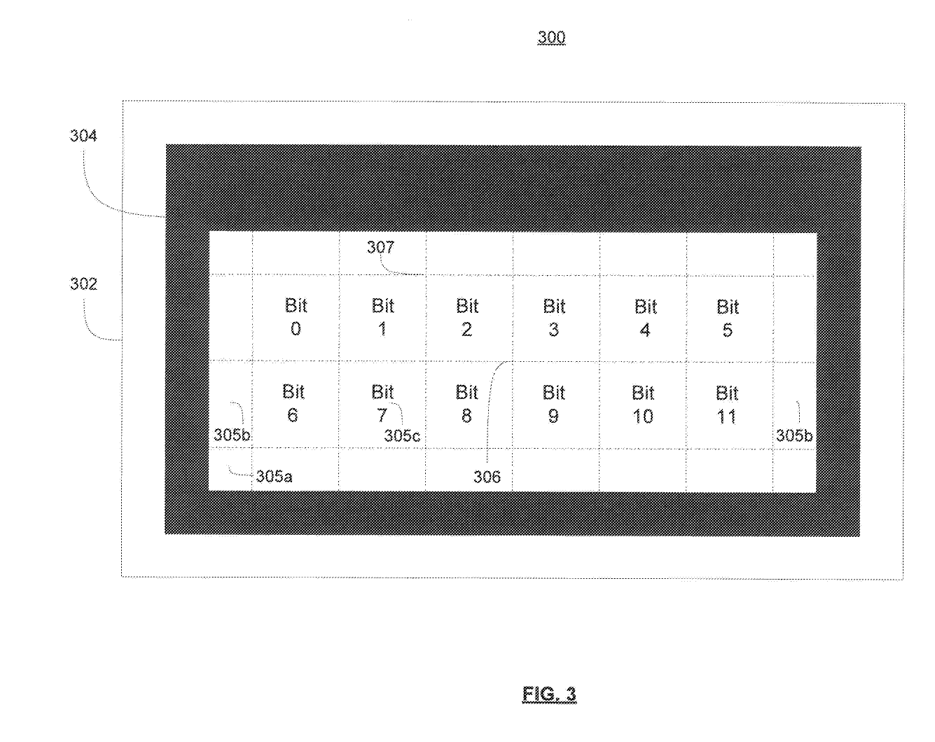

The particular pattern of the data indicators 208 can be designed in order to represent encoded data. As will be explained with reference to FIG. 3, according to some embodiments, a pattern of the data indicators 208 can be established by considering the interior area 206 as comprising a matrix or grid, such that each element of the matrix or grid can be populated with a single data indicator 208.

According to some embodiments, the proportions and/or scaling of the elements of the target can be used to convey information. For example, the target 200 is shown such that the edge regions 212 of the base 202 are one unit wide and the border 204 is one unit wide, in FIG. 2, the header 210 is shown with a height of one unit, but could also be two or more units, according to some embodiments.

As will be described further below, the interior area 208 is divided into a matrix with corner cells that are one square unit, with outside edge cells that are two square units, and with interior ceils (“data zones”) that are four square units. The interior cells may contain a one-unit data indicator 208, which, in the case of the disc data indicator 208 shown, means that the diameter of the disc is one unit.

When considering the dimensions of the target 200, at least two different frames of reference can be used. First, the actual dimensions of the target 200 can be measured. For example, the target might have a width of 4′6″ and a height of 2′9″,which are considered its “actual” or “true” dimensions. Second, when an image of the target 200 is captured, for example, by the image sensor, the dimensions of the target 200 can be determined relative to the image. As seen in the image, the target might have a width of 180 pixels and a height of 110 pixels. Generally speaking, when a dimension of the target is referred to in pixels, it is in reference to the dimension of the target in an image of the target.

According to some embodiments, the target 200 may be constructed by selecting a base with a retro-reflective surface (e.g. with a retro-reflective tape), and then over-laying the retro-reflective surface with a non-reflective material in order to provide the interior 208, a non-reflective portion of the base 202 outside the border 204, etc. In FIG. 2, as shown, the white areas may represent the retro-reflective surface.

In the example of FIG. 2, a 12-bit binary code is used to encode a target identifier number using the data indicators 208 to represent a value of “1”.

The white areas of target 200 may be achieved by a variety of means. According to some embodiments, the white areas of the target 200 may include a retro-reflective surface. For example, an overlay may be used, such as by placing a surface overlay representing the black areas of the target 200 (i.e. the interior area 206 and the edge regions 212) over a retro-reflective base 202. In this case, the data indicators 208 may be achieved by using disc cut-outs or holes in the overlay of the interior area 206, or by printing or overlaying discs on top of the overlay of the interior area 206, in another example, the white and black areas of the target 200 may be achieved by printing or painting contrasting colors, or retro-reflective and black, etc. If should be understood that other alternatives similar to these examples can be used, such as by using an overlay surface, paint, or printing to achieve the white areas of the target 200 rather than the black areas.

The particular configuration of retro-reflective areas and non-reflective areas, or values of “1” and “0” may be varied. For example, as shown in FIG. 2, the white areas may represent non-reflective areas of the sign. Holes that are exposed as objects may have values of “0”, and non-exposed areas may have values of “1”.

Referring to FIG. 3, there is shown a target 300. (The target 300 is shown with an opposite color scheme as the target 200).

As previously described for the target 200, the target 300 comprises a base 302, a border 304, and an interior space 306. (The header region above the border 304 is not numbered).

The interior space 308 can be considered to comprise a grid 307. The grid 307 is represented in stippled lines for the sake of description, though, according to some embodiments, these stippled lines are not actually visible on the target 300.

The grid 307 is dimensioned according to the scale of the target 300. According to some embodiments, the outside (perimeter) cells of the grid 307 have a dimension that is one unit (e.g. the corner cells 305a are one square unit, and the edge cells 305b are either 2×1 or 1×2 as shown). The inside cells 305c of the grid 307 have an area of four square units. Each of the inside cells 305c of the grid 307 can be considered a “data zone”.

According to some embodiments, the particular scaling and spacing of the grid—in other words, the particular scaling and spacing of the data indicators—allow the navigation system to identify a particular data indicator as being in a particular cell (or data zone) of the grid at various distances.

The pattern of data indicators found on the interior area 306 can be used to represent encoded information. For example, as indicated for the target 300, the information can be encoded as a binary number.

Referring to the grid 307, the location of each interior cell 305c can indicate a binary digit. In the example shown in FIG. 3, the upper-left cell represents the least-significant bit, and the lower-right cell represents the most-significant bit. Since the interior cells of the grid represent a six-by-two grid or matrix, there are twelve bits available for encoding.

In the examples of target 200 and target 300, the presence of a data indicator (e.g. 208) represents a binary ‘1’, and a 12-bit binary number can be established based on the presence (‘1’) of a data indicator, or the absence (‘0’) of a data indicator.

Any number of interior ceils (e.g. twelve) and any layout of the grid (e.g. six-by-two) may be used. Furthermore, the order of the binary digits can be varied (e.g. the bottom right corner could be the least-significant bit, etc.).

According to some embodiments, the corner cells 305a and/or the edge cells 305b may be optional. For example, a target could omit the corner cells 305a and the edge cells 305b so that the cells 305c (that are available for the data indicators) are directly adjacent the border 304.

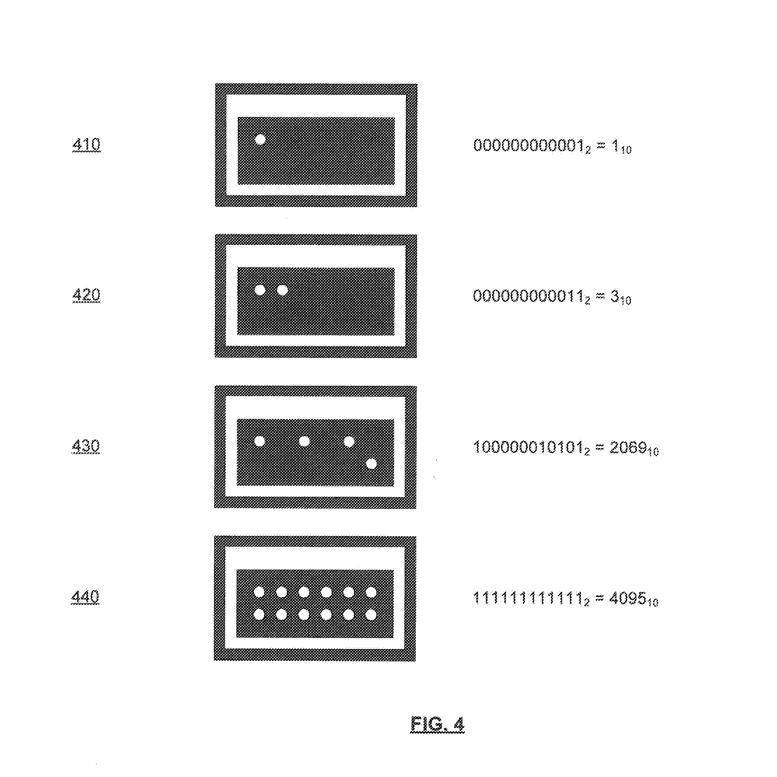

Referring to FIG. 4, multiple examples of targets with binary numbers encoded by the presence or absence of data indicators are shown. In each example, the upper-left element represents the least significant digit of the binary number, and the lower-right element represents the most significant digit. Other assignments of elements to digits are possible.

Target 410 represents the binary number 1 (which is the decimal number 1). Target 420 represents the binary number 11 (which is the decimal number 3). Target 430 represents the binary number 100000010101, which is the binary number 2089. Target 440 represents the binary number 111111111111 (which is the binary number 4095).

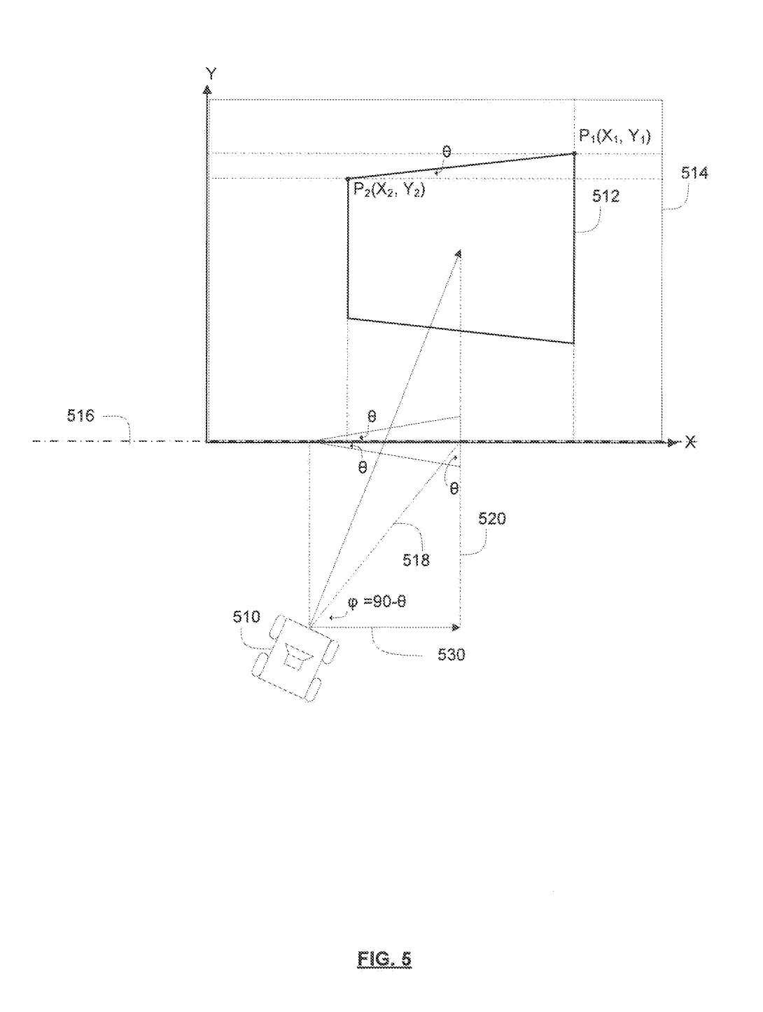

Referring to FIG. 5, there is shown a depiction of a robot 510 approaching a target 512. An image 514 is shown, as captured by a camera mounted on the robot 510.

In order to illustrate the geometric relationships of the scenario of the robot 510 approaching the target 512, the image 514 is shown as projected in the same plane on which the robot travels. Thus, the area below the dashed line 516 shows a plan view (e.g. a robot travelling on a floor), while the area above the dashed line 516 shows the image 514 projected. In other words, the plane above the dashed line 516 is perpendicular to the plane below the dashed line 516, such that the Y-axis relative to the image 514 is oriented “up” relative to the robot.

In the scenario depicted in FIG. 5, the robot 510 is separated from the target 512 by a target distance 518, and is offset from the centerline 520 of the robot route by a skew angle θ_{skew}.

The target distance 518 is calculated when the robot 510 is approaching the target 512 (which is shown in the image 514), and is used by the robot vision system to determine the distance that the robot needs to travel towards the target. Depending on the electronic map and the robot route, the robot vision system may guide the robot 510 to perform an appropriate action (e.g. “go straight”, “turn left”, “turn right”, “pick up package”, “drop off package”, etc.) when the robot is a specific distance from the target, such as may be determined by a distance threshold.

According to some embodiments, the target distance 518 can be calculated using the image resolution (e.g. the width and height of the image, as measured in pixels), the actual dimensions of the target (e.g. as measured in feet), and the field-of-view angle of the camera, according to the following formula:

$${T}_{D} = \frac{{T}_{H} * {I}_{Wpix}}{2 * {T}_{Hpix} * Tan ( \frac{{θ}_{FOV}}{2} )}$$

where T_{D} is the target distance, T_{H} is the actual height of the target 512 (e.g. as measured in feet), I_{Wpix} is the width of the image (e.g., as measured in pixels), T_{Hpix} is the height of the target 512 in the image 514 (e.g. as measured in pixels), and θ_{FOV} is the field-of-view angle.

According to some embodiments, the target distance T_{D} may be calculated using the ratio of the actual width of the target 512 to the width of the target 512 in the image 514 (e.g. as measured in pixels). Referring to the formula above, T_{W} and T_{Wpix} may be substituted for T_{H} and T_{Hpix} respectively, where T_{W} is the actual width of the target 512 (e.g. as measured in feet) and T_{Wpix} is the width of the target 512 in the image 514 (e.g. as measured in pixels).

As shown in FIG. 5, the robot 510 is traveling towards the center of the target 512, but is approaching the target 512 from the left of the centerline 520 of the robot route, in this case, the target 512 is skewed, as captured in the image 514, with an angle relative to the floor. The skewed projection of the target 512 in the image 514 can be used to determine the skew angle θ_{skew} between the current path of the robot (i.e. the direction of the line 518) and the centerline of the robot route 520.

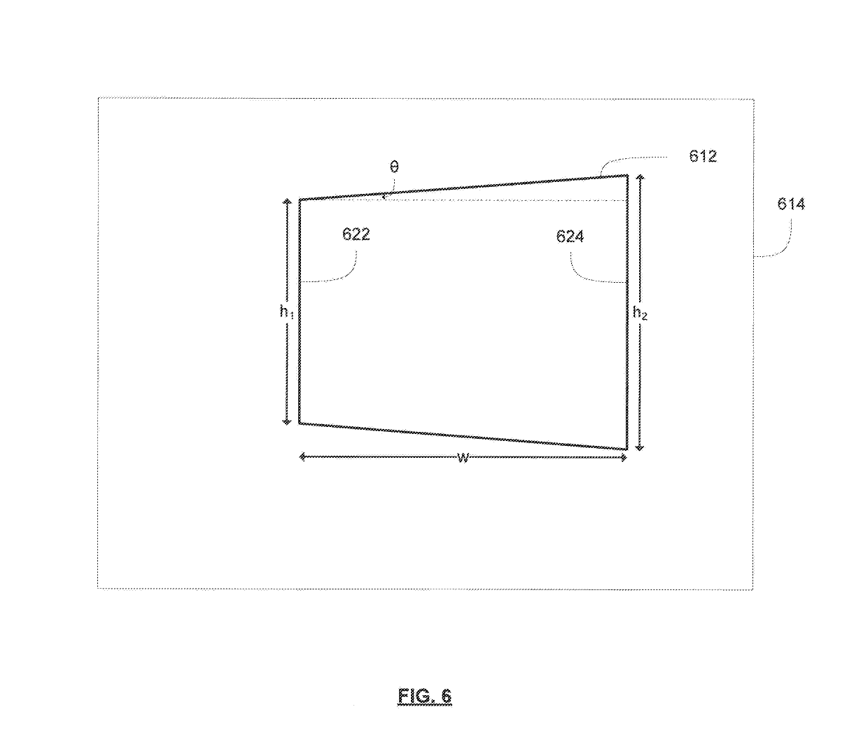

Referring to FIG. 6, there is shown an illustration depicting the calculation of the skew angle θ_{skew} according to some embodiments.

A target 612 is shown in an image 614, such as an image captured by a camera mounted on a robot. The target 612 includes a left side edge 622 and a right side edge 624. The height of each side edges (h₁ and h₂, respectively) can be determined in the image 614, such as by measuring the height of each edge in pixels. Similarly, the width (w) of the target 612 in the image 614 can be determined.

According to some embodiments, the skew angle θ_{skew} can be calculated according to the formula:

$${θ}_{skew} = {tan}^{- 1} \frac{( {h}_{2} - {h}_{1} )}{2 w}$$

where θ_{skew} is the skew angle, h₁ and h₂ are the heights of the side edges of the sign, and vv is the width of the sign.

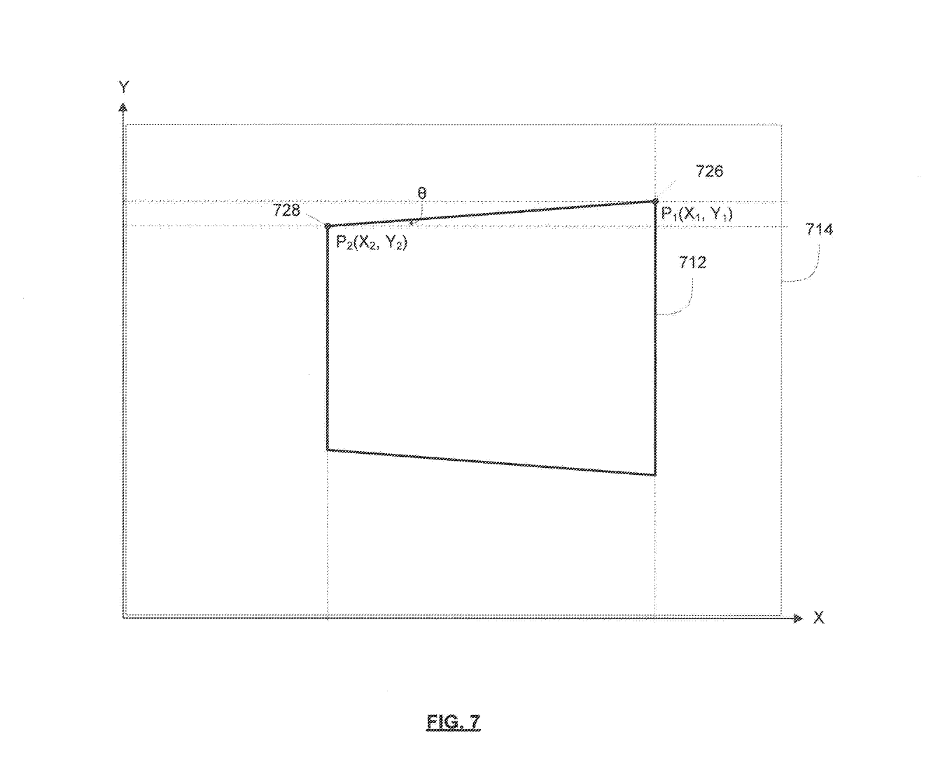

Referring to FIG. 7, there is shown an illustration depicting the calculation of the skew angle θ_{skew} according to some embodiments.

A target 712 is shown in an image 714, such as an image captured by a camera mounted on a robot. The target 712 includes a top-right corner 726 and a top-left corner 728. The image 714 is shown relative to an X-Y axis, in order to provide a frame of reference (e.g. an X-Y grid). The top-right corner 726 is located at a point P₁ having coordinates (X₁, Y₁), and the top-left corner 728 is located at a point P₂ having coordinates (X₂, Y₂).

According to some embodiment, the skew angle θ_{skew} can be calculated according to the formula:

$${θ}_{skew} = {tan}^{- 1} \frac{( {Y}_{1} - {Y}_{2} )}{( {X}_{1} - {X}_{2} )}$$

where θ_{skew} is the skew angle, Y₂ and Y₁ are the y-coordinates of the top-left and top-right corners respectively, and X₂ and X₁ are the x-coordinates of the top-left and top-right corners respectively.

Referring again to FIG. 5, the skew angle relative to the floor (i.e. below the line 518), the skew angle θ_{skew} relative to the target distance 518 and the route angle offset φ are shown. According to some embodiments, the vision system of the robot 510 can use the route angle offset φ and the route distance offset 530 in order to provide the drive system of the robot 510 with instructions for steering the robot towards the centerline of the robot route 520, and, thus, the center of the target 512.

The skew angle θ_{skew} projected above the line 516 in the X-Y plane (i.e. above the line 516) is symmetrical to the angle projected below the line 516 on the floor, which is therefore also labelled as θ_{skew}. This is congruent with the angle between the line 518 and the line 520. Thus, the route distance offset 530 can be calculated as:

Route Distance Offset=T_{D}·sin θ_{skew}

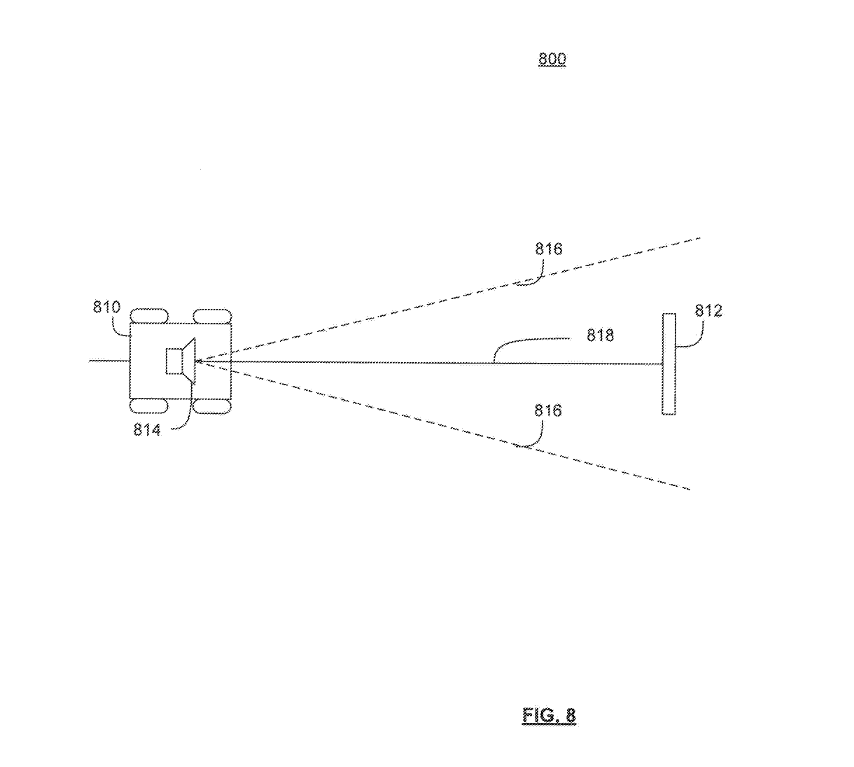

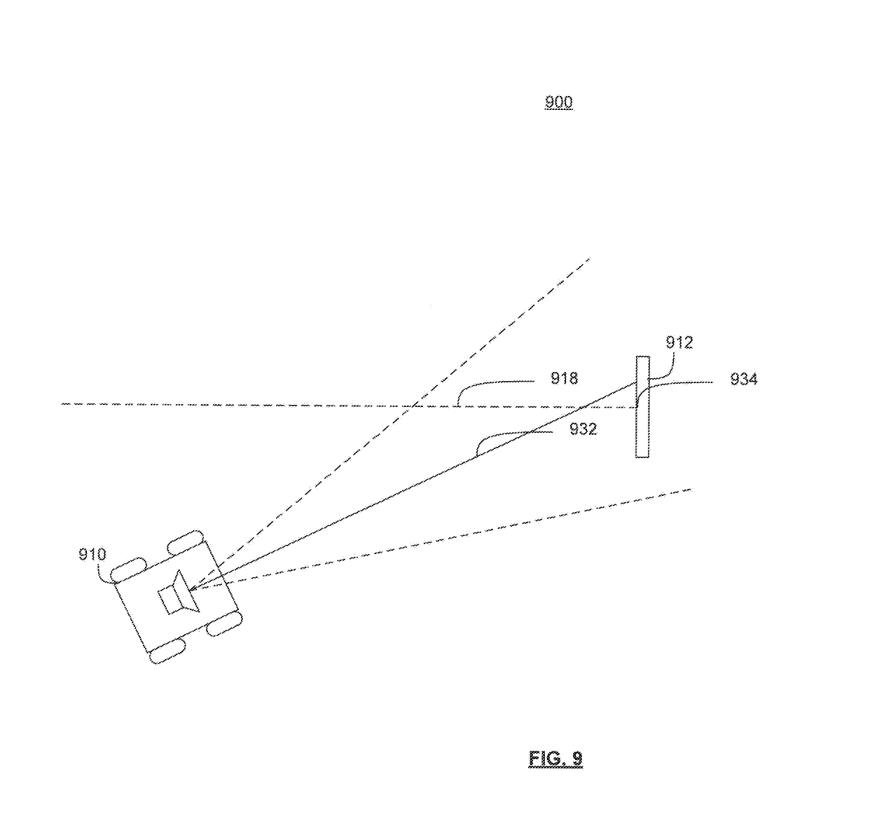

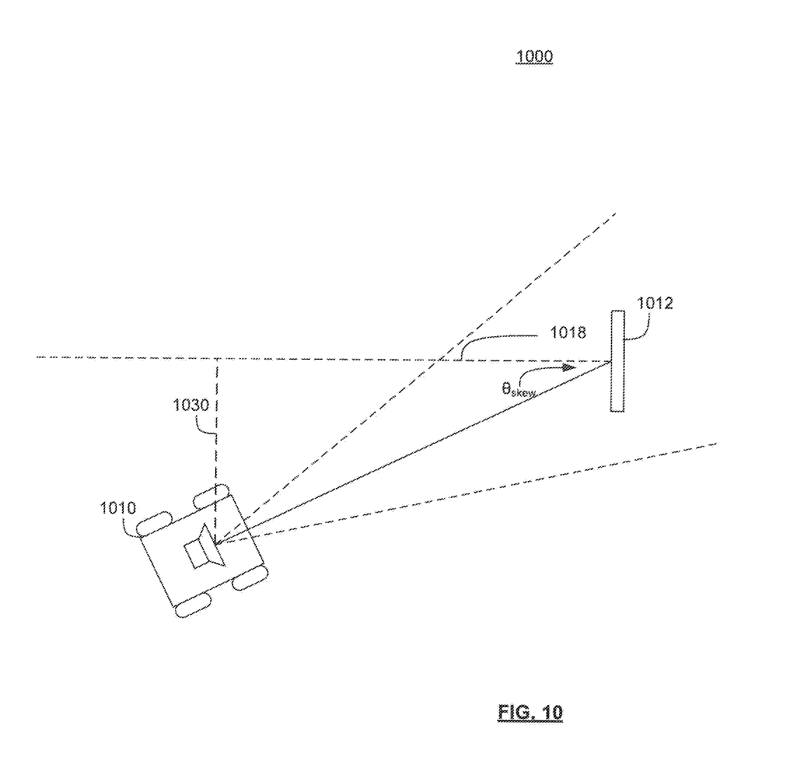

Three different navigation situations, 800, 900, and 1000 are depicted in FIG. 8, FIG. 9, and FIG. 10 respectively. According to some embodiments, in order to ensure that a robot is traveling along the robot route and towards the centerline of a target, the robot vision system determines which navigation situation the robot is currently experiencing, and then the navigation control system issues appropriate commands to the robot drive system in order to steer the robot along the robot route accordingly.

Referring to FIG. 8, there is shown a navigation scenario 800 in which a robot 810 approaches a target 812. A camera 814 mounted on the robot 810 has a field of view illustrated by the stippled lines 816.

In the navigation scenario 800, the robot 810 is travelling along the path 818 properly, and towards the center of the target 812. Since the robot is on or near the centerline of the robot route 818, and the skew angle is zero or very small (i.e. below the angle tolerance threshold), no path adjustment is necessary, in this case, the navigation control system will issue a “go straight” command to the drive system.

Referring to FIG. 9, the navigation scenario 900 is such that the robot 910 is travelling to the right of the robot route 918, and not towards the center of the target 912.

In the navigation scenario 900, the robot 910 is travelling on the right side of the robot route 918, and is not travelling towards the center of the target 912. When the vision system of the robot 910 determines that the robot 910 is not traveling towards the center of the target 912, the navigation control system of the robot 910 steers the robot 910 so that it is travelling towards the center of the target 912.

Once the robot 910 is aligned with the center of target 912, the robot 910 will experience the navigation scenario 1000 as shown in FIG. 10.

Referring to FIG. 10, the navigation scenario 1000 is such that the robot 1010 is travelling to the right of the robot route 1018, and towards the center of the target 1012.

In the navigation scenario 1000, the robot 1010 is travelling towards the center of the target 1012, and is approaching the robot route 1018 from the right relative to the center of the robot route 1018. According to some embodiments, the vision system of the robot 1010 may calculate the skew angle θ_{skew}, the robot route angle, and the route distance offset 1030. If the skew angle θ_{skew} is below an angle tolerance threshold, then the navigation control system will give the drive system a “go straight” command.

However, if the skew angle θ_{skew} is above the angle tolerance threshold, the navigation control system will give the drive system an “adjust left” command, which will steer the robot 1010 towards the robot route 1018, and then right towards the center of the target 1012, based on the route distance offset 1030.

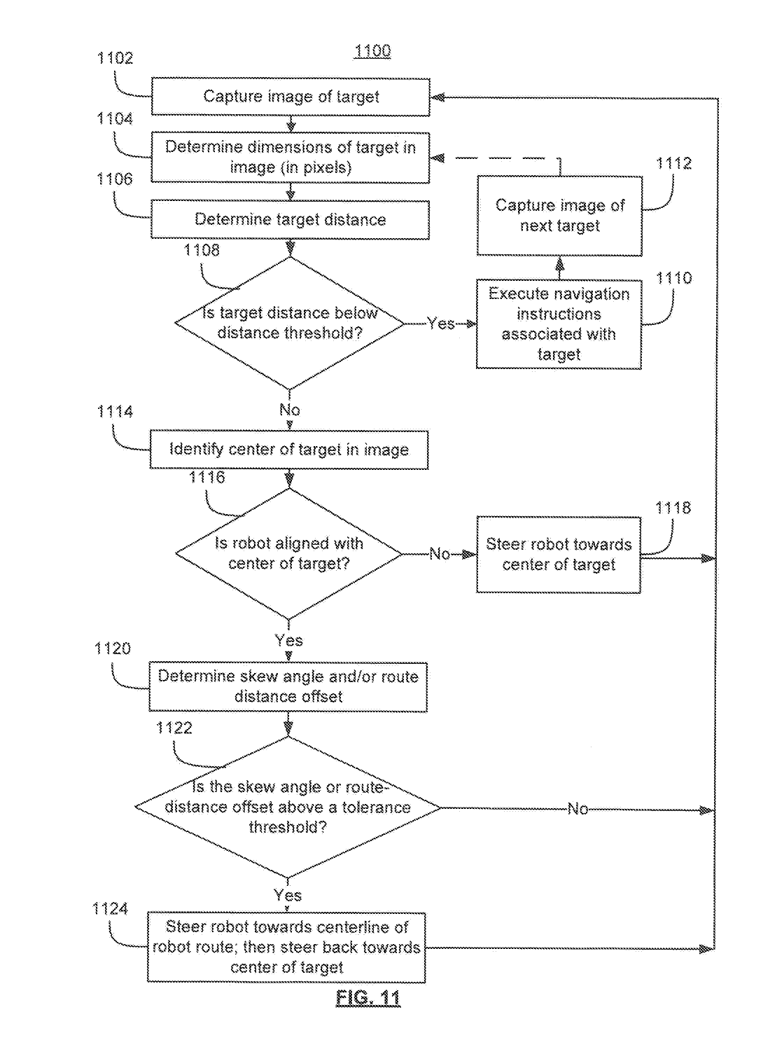

Referring to FIG. 11, there is shown a method 1100 for navigating a robot along a route. The method 1100, as depicted, assumes that the robot is advancing in a generally forward direction throughout the method.

The method begins at step 1102, when an image sensor or camera mounted on the robot captures an image of a target as previously described. Prior to capturing the image of the target, the physical dimensions of the target (e.g. as measured in feet, meters, etc.) are available to the robot. Similarly, the resolution of the image (e.g. as determined by the image sensor or camera, measured in pixels), and the field-of-view angle of the image sensor or camera are available to the robot.

At step 1104, the dimensions of the target in the image are determined (e.g. as measured in pixels). According to some embodiments, this may comprise identifying the target within the image, and then measuring the length of the edges of the target in pixels (e.g. any or all of the top, bottom, left, or right edges).

At step 1106, the target distance is determined. The target distance is the distance from the robot to the target that the robot is currently approaching.

According to some embodiments, the dimensions of the image (e.g. as may be measured in pixels), the dimensions of the target in the image (e.g. as may be measured in pixels), the dimensions of the target (i.e. the actual dimension of the target, as may be measured in feet meters, etc.), and the field-of-view angle of the camera may be used to calculate the target distance, as previously described.

At step 1108, the robot determines whether the target distance is below a distance threshold. The distance threshold is used to estimate whether the robot has arrived at the target. If the robot has arrived at the target, then the robot is in a position in which it can execute the instructions or commands associated with that target.

For example, if the distance threshold is two feet, and the target distance is less than two feet, then the robot will execute the instructions or commands associated with the target. The distance threshold may be provided by a user (such as an operator, system administrator, engineer, etc.), and may be stored locally in memory on the robot, or provided over a communications network in communications with the robot.

According to some embodiments, a different distance threshold may be provided for different targets, and/or, a distance threshold may be provided based on the type of action associated with the target.

If, at step 1108, the robot determines that the target distance is below the distance threshold, then the method proceeds to step 1110. At step 1110, the robot executes the navigation instructions associated with the target.

According to some embodiments, the instructions or commands associated with the target may include steering instructions, such as turn left or turn right, as well as other driving commands such as stop, pause, progress forward, alter speed, reverse, etc. Other instructions can include instructions for the payload, such as pick up the payload, or deliver the payload,

The instructions or commands may provide the robot with a subsequent target (e.g. from the electronic map). In this case, the method 1100 proceeds to step 1112, and an image of the next target is capture. The method 1100 then returns to step 1104 (with the new image of the next target), thus allowing the robot to iterate through the method 1100 for the next target, as indicated by the stippled line.

If, at 1108, the robot determines that the target distance is not below the distance threshold, then the method 1100 proceeds to step 1114.

At step 1114, the center of the target in the image is identified. For example, this could be accomplished by dividing in half the dimensions determined in the step 1104. According to some embodiments, the center of the target in the image may be identified prior to step 1108. For example, the center of the target in the image may be identified along with, or after step 1104. After the center of the target in the Image has been identified, the method 1100 proceeds to step 1116.

At step 1116, the method determines whether the robot is aligned with the center of the target. For example, this can be accomplished by using the center of the target that was identified during step 1114. The scenario in which the robot is not aligned with the center of the target is shown in FIG. 9.

If, at step 1116, the method determines that the robot is not aligned with the center of the target, then the method proceeds to step 1118, in which the robot is steered towards the center of the target. Referring, again, to FIG. 9, this would mean, for example, steering the robot 910 to the right (e.g. pivoting the robot, or turning the robot) so that the robot 910 is aligned with the center of the target 912. The robot 910 can be deemed to be aligned with the target 912, when the line 932 projecting from the center of the robot 910 intersects the point 934 at the center of the target 812.

If, at step 1116, the method determines that the robot is aligned with the center of the target, then the method proceeds to step 1120. The scenario in which the robot is aligned with the center of the target is shown in FIG. 10.

At step 1120, the skew angle and/or the route distance offset are determined The skew angle, as previously described, is the angle of the target to the floor, as measured in the image. The route distance offset, as previously described, is the distance between the robot and a centerline extending from the target. The skew angle θ_{skew} and route distance offset 1030 are shown in FIG. 10.

According to some embodiments, the height of one vertical edge of the target (as measured in the image) relative to the height of the opposite vertical edge of the target may be used to calculate the skew angle, as previously described.

According to some embodiments, the skew angle may be calculated by measuring the difference in the vertical positions of the top-right and top-left corners (or vise-versa) and dividing this difference by the difference in the horizontal positions of the top-right and top-left corners (or vice-versa), and then calculating the arctangent, as previously described.

According to some embodiments, it is possible to calculate a route angle offset. The route angle offset is the angle measured from the current path of the robot to the centerline of the robot route (e.g. projecting from the center of the target).

After the skew angle and/or route distance offset have been determined, the method proceeds to step 1122. At step 1122, the robot determines whether the distance offset is above a distance tolerance threshold, and/or if the skew angle is above an angle tolerance threshold.

The distance tolerance threshold is the maximum distance that the robot is permitted to vary from the robot route before corrective action (e.g. steering) is implemented. If the route distance offset is greater than the distance tolerance threshold, then the robot is deemed to have strayed from the robot route. The distance tolerance threshold may be provided by a user (such as an operator, system administrator, engineer, etc.), and may be stored locally in memory on the robot, or provided over a communications network in communications with the robot.

The angle tolerance threshold is the maximum angle that the robot is permitted to vary from the robot route before corrective action (e.g. steering) is implemented. If the skew angle is greater than the angle tolerance threshold, then the robot, is deemed to have strayed from the robot route. The angle tolerance threshold may be provided by a user (such as an operator, system administrator, engineer, etc.), and may be stored locally in memory on the robot, or provided over a communications network in communications with the robot.

According to-some embodiments, the distance tolerance threshold and the angle tolerance threshold may be dependent upon (or vary with) the target distance. For example, when the robot is closer to the target, a larger skew angle may be tolerated than when the robot is farther away from the target.

According to some embodiments, the navigation system may first determine whether a steering instruction is necessary based on the route distance offset, and then, subsequently, whether an additional steering instruction is necessary based on the skew angle. For example, if the route distance offset is above a distance tolerance threshold, then a gross adjustment may be necessary in order to steer the robot back towards the robot route before re-aligning the robot with the center of the target.

When the route distance offset and/or skew angle (as the case may be) is above the distance tolerance threshold or angle tolerance threshold, then the method proceeds to step 1124, and the robot is steered towards the centerline of the robot route (i.e. steered right or left, as appropriate). When the steering is implemented in response to the route distance offset being above the distance tolerance threshold, and/or the skew angle being above the angle tolerance threshold, the robot may be steered towards a centerline (e.g. the robot route) extending from the target, for example, in a direction that is perpendicular to the centerline.

According to some embodiments, the steering in step 1124 can involve multiple steering stages. For example, the robot 1010 could be steered left so that It was perpendicular to the line 1018, driven straight towards the line 1018, and then steered right so that it was aligned with the line 1018 and the center of the target 1012. The robot need not be driven perpendicular to the line 1018, and may approach the line 1018 at other angles.

According to some embodiments, at step 1124, the robot can be steered towards the robot route 1018 (e.g. at a path perpendicular to the robot route 1018, or at some other angle), and driven towards the robot route 1018 for a distance that is based on the route distance offset determined during step 1120.

After the robot has been steered towards the centerline of the robot route, and then steered towards the center of the target, the method proceeds to step 1102, as described above.

If, at step 1122, the robot determines that the route distance offset and/or skew angle Is not above the tolerance threshold (i.e. the robot has not varied significantly from the robot route), then no corrective action (e.g. steering) is required, and the robot continues to progress forward in a more-or-less straight line, and the method progresses to step 1102, as previously described.

While the above description provides examples of one or more apparatus, methods, or systems, it will be appreciated that other apparatus, methods, or systems may be within the scope of the claims as interpreted by one of skill in the art.

1. A method for navigating a robot along a route, comprising:
a) providing a target comprising a plurality of data zones and a plurality of data indicators organized with no more than one data indicator located within one data zone, the target having a target code based on which of the data zones contains the plurality of data indicators;
b) using an image sensor mounted on the robot to capture an image of a target;
c) determining a target distance between the robot and the target based upon the image; and
d) if the target distance is below a distance threshold, then determining an instruction based on the target code and commanding the robot based on the instruction.

2. The method of claim 1, wherein the target distance is determined based on a resolution of the image, a dimension of the target, and a field-of-view angle of the image sensor.

3. The method of claim 2, wherein the resolution of the image includes a height of the image and the dimension of the target includes a height of the target.

4. The method of claim 3, wherein the target distance is determined based on the formula:
$${T}_{D} = \frac{{T}_{H} * {I}_{Wpix}}{2 * {T}_{Hpix} * Tan ( \frac{{θ}_{FOV}}{2} )}$$
wherein T_{D} is the target distance, T_{H} is the height of the target, I_{Wpix} is the width of the image measured in pixels, T_{Hpix} is a height of the target in the image measured in pixels, and θ_{FOV} is the field-of-view angle.

5. The method of claim 1, further comprising;
a) determining a skew angle between the robot and the target; and
b) if the skew angle is above an angle tolerance threshold, then steering the robot towards a center of the target.

8. The method of claim 5, wherein the skew angle is determined based on a height of a first side of the target, a height of a second side of the target, and a width of the target.

7. The method of claim 8, wherein the skew angle Is determined based on the formula:
$${θ}_{skew} = {tan}^{- 1} \frac{{h}_{2} - {h}_{1}}{2 \cdot w}$$
wherein θ_{skew} is the skew angle, h₂ is the height of the second side of the target, h₁ is the height of the first side of the target, and w is the width of the target.

8. The method of claim 5, wherein the skew angle is determined based on the formula:
$${θ}_{skew} = {tan}^{- 1} \frac{( {Y}_{1} - {Y}_{2} )}{( {X}_{1} - {X}_{2} )}$$
where θ_{skew} is the skew angle, Y₂ and Y₁ are, respectively, the y-coordinates of a top-left corner and a top-right corner of the target in the image, and X₂ and X₁ are, respectively the x-coordinates of a top-left corner and a top-right corner of the target in the image.

9. The method of claim 1, further comprising:
a) determining a route distance offset between the robot and a centerline extending from the target; and
b) if the route distance offset is above a distance tolerance threshold, then steering the robot towards the centerline.

10. The method of claim 1, wherein the instruction is one of: changing direction; picking up a payload; and delivering the payload.

11. A robot navigation system, comprising:
a target comprising a plurality of data zones and a plurality of data indicators organized with no more than one data indicator located within one data zone, the target having a target code based on which of the data zones contains the plurality of data indicators; and
a robot having an image sensor for capturing an image of the target, a drive system for driving and steering the robot, and a processing unit, the processing unit configured to:
a) determine a target distance between the robot and the target based on the image; and
b) if the target distance is below a distance threshold, then determine an instruction from the target code and instruct the drive system to steer the robot based on the instruction.

12. The robot navigation system of claim 11, wherein the target distance is determined based on a resolution of the image, a dimension of the target, and a field-of-view angle of the image sensor.

13. The robot navigation system of claim 12, wherein the resolution of the image includes a height of the image and the dimensions of the target defines a height of the target.

14, The robot navigation system of claim 12, wherein the target distance is determined based on the formula:
$${T}_{D} = \frac{{T}_{H} * {I}_{Wpix}}{2 * {T}_{Hpix} * Tan ( \frac{{θ}_{FOV}}{2} )}$$
wherein T_{D} is the target distance, T_{H} is the height of the target, I_{Wpix} is the width of the image measured in pixels, T_{Hpix} is a height of the target in the image measured in pixels, and θ_{FOV} is the field-of-view angle.

15. The robot navigation system of claim 11, wherein the processing unit is further configured to:
a) determine a skew angle between a robot and the target; and
b) if the skew angle is above an angle tolerance threshold, then instructing the drive system to steer the robot toward a center of the target.

18. The robot navigation system of claim 15, wherein the skew angle is determined based on the formula:
$${θ}_{skew} = {tan}^{- 1} \frac{{h}_{2} - {h}_{1}}{2 \cdot w}$$
wherein θ_{skew} is the skew angle, h₂ is the height of the second side of the target, h₁ is the height of the first side of the target, and w is the width of the target.

17. The robot navigation system of claim 15, wherein the skew angle is determined based on the formula:
$${θ}_{skew} = {tan}^{- 1} \frac{( {Y}_{1} - {Y}_{2} )}{( {X}_{1} - {X}_{2} )}$$
where θ_{skew} is the skew angle, Y₂ and Y₁ are, respectively, the y-coordinates of a top-left corner and a top-right corner of the target in the image, and X₂ and X₁ are, respectively the x-coordinates of a top-left corner and a top-right corner of the target in the image.

18. The robot navigation system of claim 11, wherein the processing unit is further configured to:
a) Determine a route distance offset between the robot and a centerline extending from the target; and
b) if the route distance offset is above a distance tolerance threshold, then instructing the drive system to steer the robot towards the centerline.

19. The robot navigation system of claim 11, wherein the instruction is one of changing direction, picking up a payload, and delivering the payload.

20. A robot-navigation target device, comprising:
a base defining a base surface;
a border attached to the base surface, enclosing an interior area comprising a matrix representing a plurality of data zones;
a plurality of data indicators, organized with each data indicator being located within one data zone;
wherein the plurality of data indicators are organized to represent encoded information based on which of the data zones contain the plurality of data indicators.

21. The robot-navigation target device of claim 19 wherein the interior area has a contrasting color relative to a color of the border and a color of the plurality of data indicators.

22. The robot-navigation target device of claim 19, wherein the plurality of data indicators are organized to represent a number.

23. The robot-navigation target device of claim 22, wherein the number is a binary number.

24. The robot-navigation target device of claim 19, wherein the base surface is a retro-reflective surface, the interior area is defined by a non-reflective overlay on the retro-reflective surface, and each of the plurality of data indicators is defined by a cut-out in the non-reflective overlay.
